(19) United States
(12) Patent Application Publication
(10) Pub. No.: US 2004/0037401 A1
(43) Pub. Date: Feb. 26, 2004

(54) Interactive voice response system and a method for use in interactive voice response system

(75) Inventors: Barry Neil Dow, Gosport (GB); Timothy David Poultney, Southampton (GB); David Seager Renshaw, Winchester (GB); Samuel Jonathan Smith, Southampton (GB)

Correspondence Address: Jerry W. Herndon, IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/317,465

(22) Filed: Dec. 12, 2002

(30) Foreign Application Priority Data
Jul. 11, 2002 (GB) 0216059.6

(51) Int. Cl. H04M 11/00

(52) U.S. Cl. 379/88.18

(57) ABSTRACT

An interactive voice response system (103) and a method for use in an interactive voice response system are provided. The interactive voice response system (103) has means for receiving telephone calls via a telephone network (102). The interactive voice response system (103) has means for accessing an application server (105) via a computer network (104) to obtain information in response to an audio input from a telephone call. A cookie (112) sent from an application server (105) relating to the access of the application server (105) in response to an audio input from a telephone call is linked to a telephone calling line identifier (110) and the cookie (112) is stored for use during subsequent telephone calls from the same telephone calling line.

### FIELD OF INVENTION

This invention relates to the field of interactive voice response systems, in particular to the area of linking telephone calls to cookies.

### BACKGROUND OF THE INVENTION

VoiceXML (Voice Extensible Markup Language) is a language for creating voice-user interfaces and is used with interactive voice response (IVR) systems. With VoiceXML, speech application development is simplified by using familiar web infrastructure, including tools and web servers.

Extensible Markup Language (XML) developed by the Worldwide Web Consortium allows web developers to create customised tags that offer greater flexibility in organising and presenting information than is possible with other HTML document coding systems. VoiceXML uses the same principles applied to IVR capabilities for voice-enabled web applications.

With VoiceXML any telephone can access VoiceXML applications on the web via a VoiceXML browser running on a telephony server. VoiceXML uses speech recognition and touchtone (Dual Tone Multi-Frequency or DTMF keypads) for input. Pre-recorded audio and text to speech (TTS) synthesis is used for output. VoiceXML also has features to control presentation logic and control flow, event handling and basic telephony connections.

So, instead of using a personal computer with a web browser to access documents or applications on the web, a telephone can be used with a VoiceXML browser to access voice enabled web sites.

An interactive voice response (IVR) system runs a browser which fetches VoiceXML documents and their associated resources such as voice recognition grammar files and audio prompts from application servers. The IVR system, having obtained the document (which defines the voice application), then parses it and performs actions appropriate to the content therein, i.e. play prompt, get DTMF input, etc.

The VoiceXML documents may be fetched from application servers in the form of web servers using the standard HTTP protocol which provides the commands used by the browser to ask a web server for information about a web page. As such, the browser software which the IVR runs is much like the Internet Explorer browser provided with Microsoft Windows (Internet Explorer and Windows are Trade Marks of Microsoft Corporation) and contains much of the same functionality such as the fetching and parsing of documents.

Web browsers also have the function of storing “cookies” which are provided by the web site from which the browser has obtained information. A cookie is a block of data which a web server stores on a client system. When a user returns to the same web site, the web browser sends a copy of the cookie back to the server. Cookies are used to identify users, to instruct a server to send a customised version of the requested web page, to submit account information for the user, and for other administrative purposes.

Cookies are also provided from web sites from which VoiceXML documents are obtained. IBM WebSphere Voice Response for AIX (IBM and WebSphere are trade marks of International Business Machines Corporation) is an interactive voice response system which deals with cookies on a per call basis. If during a telephone call, a document is fetched from a web site and a cookie is also delivered along with it, the cookie can be used for subsequent transactions within that call only.

The terms web server, web browser, web page, etc, are used in the context of the World Wide Web. However, the described system and method applies to any type of computer network on which cookies may operate and which is accessible by an IVR system.

VoiceXML enables voice access of web applications. The described system and method can be used with other voice or audio interface languages that enable access via a computer network to suitable documents provided on an application server of the network.

An aim of the present invention is to enable browser software to store a cookie for an IVR system user for longer than the duration of one telephone call only.

### DISCLOSURE OF THE INVENTION

According to a first aspect of the present invention there is provided an interactive voice response system comprising: means for receiving telephone calls via a telephone network; means for accessing an application server via a computer network to obtain information in response to an audio input from a telephone call; means for receiving a cookie from an application server relating to the access of the application server in response to an audio input from a telephone call; linking means for linking the cookie to a telephone calling line identifier; and storage means for storing the cookie for use during subsequent telephone calls from the same telephone calling line.

Preferably, the application server controls access to documents which are enabled for use with audio input and output. The documents may be VoiceXML documents.

The audio input from a telephone call may be one of voice input, recorded audio input, dual-tone multiple frequency input, fax signal input.

The system may include a telephony server which runs browser software with user interaction provided via a telephone. The system may also include a voice server for translating data commands to and from audio input using one of speech recognition and text to speech applications.

In one embodiment, the computer network may be the Internet and the application server is a web server.

The storage means may be a database.

According to a second aspect of the present invention there is provided a method for use in an interactive voice response system, comprising: receiving telephone calls via a telephone network; accessing an application server via a computer network to obtain information in response to an audio input from a telephone call; receiving a cookie from an application server relating to the access of the application server in response to an audio input from a telephone call; linking the cookie to a telephone calling line identifier; and storing the cookie for use during subsequent telephone calls from the same telephone calling line.

Preferably, the application server controls access to documents which are enabled for use with audio input and output. The documents may be VoiceXML documents.

The audio input from a telephone call may be one of voice input, recorded audio input, dual-tone multiple frequency input, fax signal input.

The method may be for use in a system including a telephony server which runs browser software with user interaction provided via a telephone. The system may also include a voice server for translating data commands to and from audio input using one of speech recognition and text to speech applications.

In one embodiment, the computer network may be the Internet and the application server is a web server.

According to a third aspect of the present invention there is provided a computer program product stored on a computer readable storage medium, comprising computer readable program code means for performing the steps of: receiving telephone calls via a telephone network; accessing an application server via a computer network to obtain information in response to an audio input from a telephone call; receiving a cookie from an application server relating to the access of the application server in response to an audio input from a telephone call; linking the cookie to a telephone calling line identifier; and storing the cookie for use during subsequent telephone calls from the same telephone calling line.

### BRIEF DESCRIPTION OF THE DRAWINGS

An embodiment of the present invention will now be described, by way of an example only, with reference to the accompanying drawings in which:

FIG. 1 is a first schematic diagram of a system including an interactive voice response system in which the present invention may be used;

FIG. 2 is a second schematic diagram of a system including an interactive voice response system in which the present invention may be used;

FIG. 3 is a diagram of an interactive voice response system in accordance with the present invention; and

FIG. 4 is a flow diagram of a method in accordance with the present invention.

### DESCRIPTION OF THE PREFERRED EMBODIMENTS

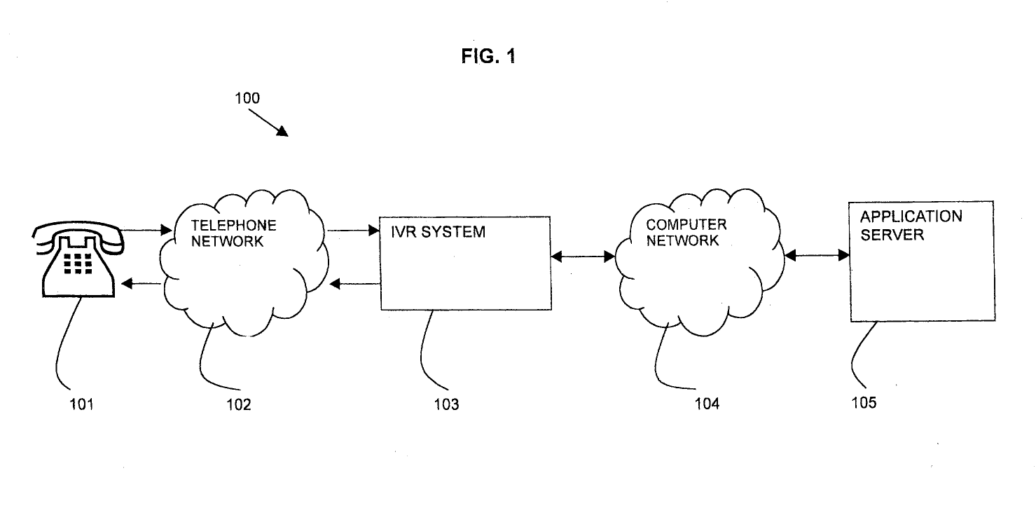

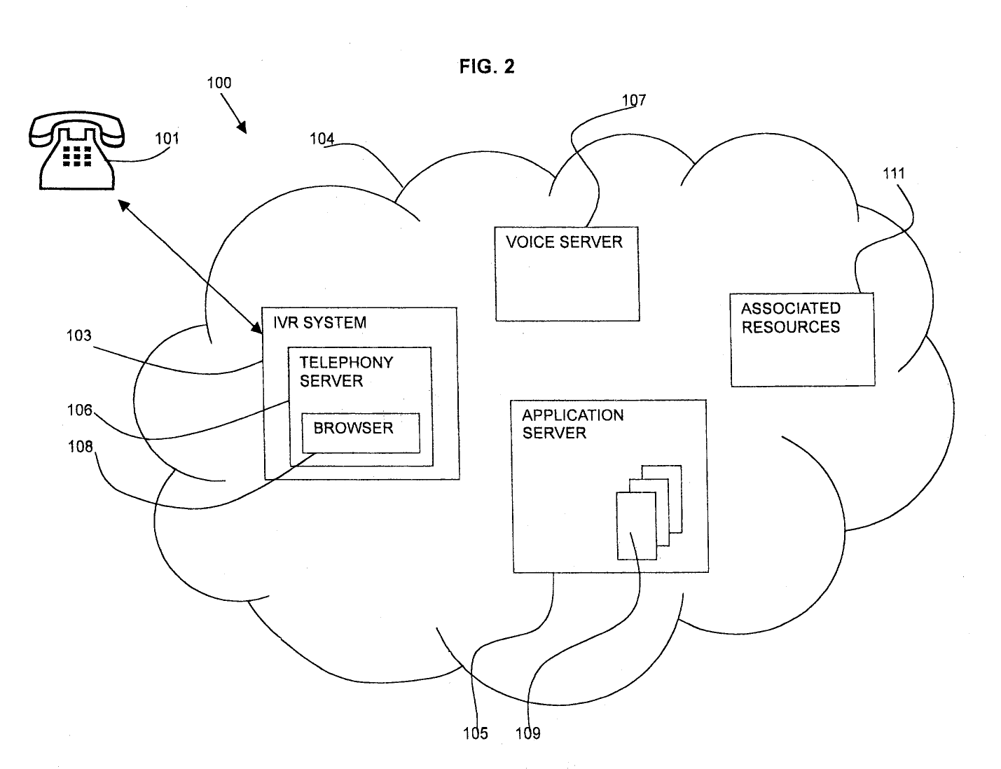

Referring to FIGS. 1 and 2, a system 100 including an interactive voice response (IVR) system 103 is shown. A caller accesses the system via a telephone apparatus 101 which is connected via a telephone network 102 to the IVR system 103. The telephone network 102 could be a public switched telephone network or a private telephone network.

The IVR system 103 is also connected to a computer network 104, for example, the Internet, an Intranet, a LAN, a WAN, etc. Also connected to the computer network 104 are one or more application servers 105 containing voice or audio enabled documents such as VoiceXML documents. The VoiceXML documents define the voice application to be used by the IVR system 103. Also connected to the computer network 104 are associated resources for use by a voice application, for example, grammar files, audio prompts, etc.

The IVR system 103 runs a VoiceXML interpreter. The IVR system 103 includes a telephony server 106 which controls the flow of inputs and outputs and telephony connections and a voice server 107 which includes speech recognition and text to speech applications. The voice server 107 may be remote from the IVR system 103, for example, connected to the IVR system 103 via the computer network 104.

The IVR system 103 runs browser software 108 for fetching documents such as VoiceXML documents 109 from an application server 105 via the computer network 104. The VoiceXML documents 109 are retrieved using HTTP protocol commands which are sent by the IVR system 103 to an application server 105 via the computer network 104.

The computer network 104 could be any type of network as discussed; however, in the context of the Internet, the VoiceXML documents 109 on an application server 105 are web pages on a web server.

A caller dials a telephone number from the telephone apparatus 101 to access a VoiceXML document 109. The telephone number is connected via the telephone network 102 to the IVR system 103. The browser 108 running in the telephony server 106 of the IVR system 103 fetches the appropriate VoiceXML document 109 from the application server 105 via the computer network 104. The browser 108 also fetches any associated resources 111 for the VoiceXML document 109 such as voice recognition grammar files and audio prompts which are needed to run the VoiceXML document 109.

The IVR system 103 having obtained the appropriate VoiceXML document 109, which also defines the voice application to be used, parses the document 109 and performs actions appropriate to the content of the document 109. Such actions may include playing an audio prompt, getting a DTMF input, etc.

Inputs to the IVR system 103 from the caller can be speech, audio recording, touchtone audio (dual-tone multi-frequency or DTMF systems), fax signals, or other forms of audio input transmitted from the telephone apparatus 101.

The IVR system 103 uses the voice server 107 which includes means for receiving and processing the inputs including speech recognition software and DTMF translation means. The inputs are processed by the voice server 107 and appropriate actions are taken based on the logic of the VoiceXML document 109 which is currently being “browsed”.

The IVR system 103 receives the information returned from the application server 105 in the form of a VoiceXML document 109 and the telephony server 106 and the voice server 107 carry out actions invoked by the VoiceXML document 109, such as playing outputs, retrieving information as inputs, etc.

The actions invoked by the VoiceXML document 109 can be processed by the voice server 107 using speech synthesis such as text to speech (TTS) to provide an audio output, by prompting a pre-recorded audio message, or other means of generating an audio output. The voice server 107 carries out appropriate actions based on the logic of the VoiceXML document 109 currently being browsed. The audio output is sent to the caller's telephone apparatus 101 via the telephone network 102.

If an application server 105 returns a cookie to the IVR system 103 with or in response to a request for information from the application server 105, the IVR system 103 stores the cookie and links it to an identifier of the caller referred to as a caller identifier. This can be done by the caller identifier being the calling line identifier (CLID) of the caller's telephone apparatus.

A calling line identifier (CLID) identifies, at the receiving end of a call, a telephone number of a caller. The telephone apparatus used may be attached to a land line or may be a mobile telephone. A single telephone apparatus may have multiple CLIDs, for example, multiple lines to a land line apparatus, or a mobile phone with a multiple telephone number SIM (Subscriber Identity Module) card. A single CLID may have more than one telephone apparatus which uses the same CLID, for example, telephone apparatus on an extension telephone line.

When the caller uses the same caller identifier to use the voice response system on future occasions, the IVR system 103 can use the caller identifier to retrieve the persistent cookies which have previously been stored in a database or similar storage means by the IVR system 103. The cookies can be used when the caller goes back to the same application servers 105.

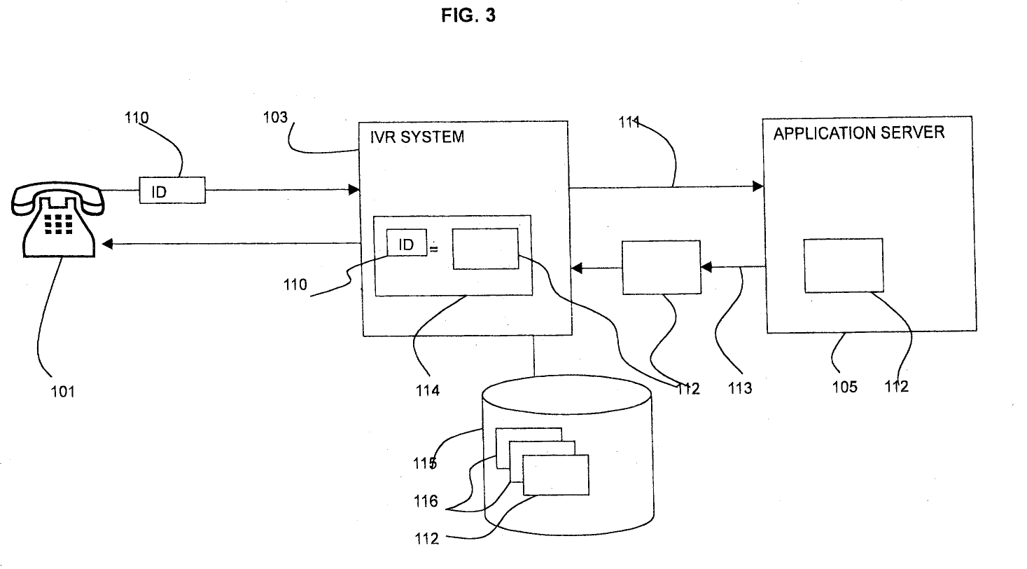

Referring to FIG. 3, a caller 101 has a caller identifier 110, for example a CLID, which is recognised and recorded in relation to an input by the browser running on the telephony server of the IVR system 103. When the IVR system 103 requests information 111 from an application server 105 on behalf of the caller with the caller identifier 110, the application server 105 generates a cookie 112 including information relating to the request 111 and any information supplied by the IVR system 103 on behalf of the caller.

The application server 105 returns the requested information 113 to the IVR system 103 and also sends the cookie 112 which it has generated for that request. The IVR system 103 links 114 the cookie 112 to the caller identifier 110 of the caller who requested the information. The IVR system 103 stores the cookie 112 together with an indication of the caller identifier 110 in a database 115 or other storage means together with other cookies 116 stored for other callers.

When the IVR system 103 receives a subsequent call from a caller with the same caller identifier 110, the IVR system 103 retrieves the cookie 112 linked to the caller identifier 110 from the database 115. When the IVR system 103 requests information from the same application server 105 that issued the cookie 112, the information in the cookie 112 is presented to the application server 105.

The use of persistent cookies has the advantage that less information is required to be downloaded from the application server 105 resulting in a faster response of the application server 105. The user experience is also improved by not making the user supply the same previously submitted information as the application server 105 may be able to reuse resources previously allocated to the cookie 112.

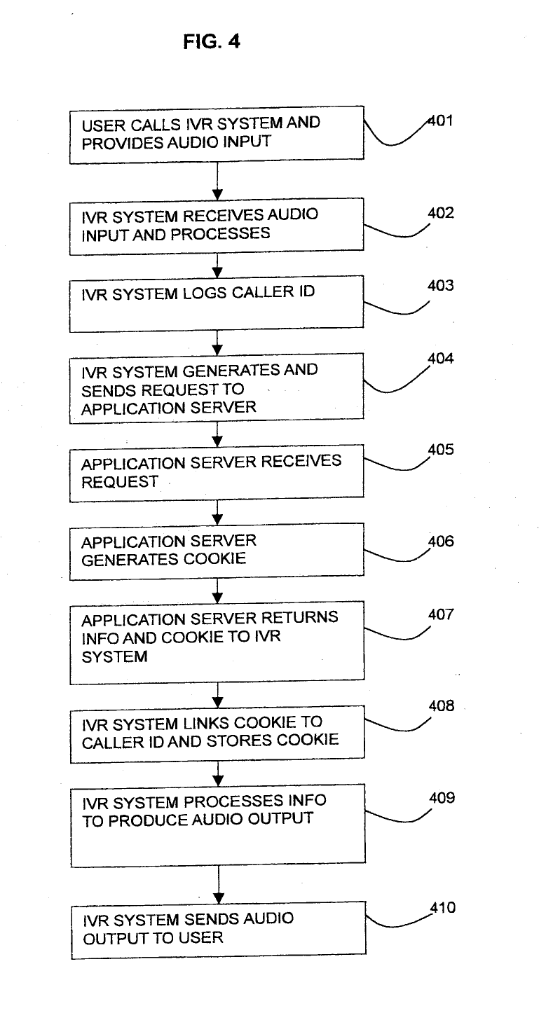

FIG. 4 is a flow diagram of a method of retrieving information from an application server as described above. At step 401 the caller calls the IVR system and provides an audio input. The IVR system receives the audio input and processes it 402. The IVR system also logs the caller ID 403. The IVR system generates and sends a request to an application server 404.

The application server receives the request 405 and generates a cookie 406 for that request. The application server returns the requested information and the cookie to the IVR system 407. The IVR system links the cookie to the caller ID and stores the cookie 408. The IVR system processes the returned information and produces an audio output 409. The audio output is sent to the caller 410.

A specific example of a use of the described system and method is now given. A caller wishes to access the VoiceXML web page on the web site of www.ibm.com. The caller dials the telephone number for the VoiceXML web page www.ibm.com/welcome.vxml for the first time.

A browser running on the IVR system retrieves the VoiceXML document from the application server, which in this case is the IBM web server. Various interactions then occur during which a login ID and password are set up between the caller and the VoiceXML document. The interactions are in the form of audio inputs by the caller and audio outputs by the IVR system generated by a voice server prompted by the VoiceXML document.

When the information generated by the interactions is submitted back to the application server, a cookie containing the information is returned to the IVR system. The cookie is linked to the CLID of the caller and is stored by the IVR system.

VoiceXML web page may link the user to other VoiceXML web pages which may also generate cookies which are returned to the IVR system, linked to the CLID of the caller and stored. During the ongoing telephone call, the caller may return to a VoiceXML web page for which a cookie has already been generated and stored by the IVR system. The IVR system will submit the cookie to the application server for the VoiceXML web page that is again being browsed and any settings and preferences can be used without repeating the interactions with the caller.

When the caller has finished the telephone call, he hangs up. The caller, or another caller using the same CLID, dials in again at a later time to a VoiceXML web page that was previously accessed in the earlier telephone call. The browser running on the IVR system realises it has a cookie for this CLID and is able to immediately submit this and the user's settings and preferences are loaded by the application server. The caller does not need to repeat interactions to supply information to the application server which was submitted in the previous telephone call.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. An interactive voice response system comprising: means for receiving telephone calls via a telephone network;
means for accessing an application server via a computer network to obtain information in response to an audio input from a telephone call;
means for receiving a cookie from an application server relating to the access of the application server in response to an audio input from a telephone call;
linking means for linking the cookie to a telephone calling line identifier; and
storage means for storing the cookie for use during subsequent telephone calls from the same telephone calling line.

2. An interactive voice response system as claimed in claim 1, wherein the application server controls access to documents which are enabled for use with audio input and output.

3. An interactive voice response system as claimed in claim 2, wherein the documents are VoiceXML documents.

4. An interactive voice response system as claimed in claim 1, wherein the audio input from a telephone call is one of voice input, recorded audio input, dual-tone multiple frequency input, fax signal input.

5. An interactive voice response system as claimed in claim 1, wherein the system includes a telephony server which runs browser software with user interaction provided via a telephone.

6. An interactive voice response system as claimed in claim 1, wherein the system includes a voice server for translating data commands to and from audio input using one of speech recognition and text to speech applications.

7. An interactive voice response system as claimed in claim 1, wherein the computer network is the Internet and the application server is a web server.

8. An interactive voice response system as claimed in claim 1, wherein the storage means is a database.

9. A method for use in an interactive voice response system, comprising:
receiving telephone calls via a telephone network;
accessing an application server via a computer network to obtain information in response to an audio input from a telephone call;
receiving a cookie from an application server relating to the access of the application server in response to an audio input from a telephone call;
linking the cookie to a telephone calling line identifier; and
storing the cookie for use during subsequent telephone calls from the same telephone calling line.

10. A method as claimed in claim 9, wherein the application server controls access to documents which are enabled for use with audio input and output.

11. A method as claimed in claim 10, wherein the documents are VoiceXML documents.

12. A method as claimed in claim 9, wherein the audio input from a telephone call is one of voice input, recorded audio input, dual-tone multiple frequency input, fax signal input.

13. A method as claimed in claim 9, wherein the system includes a telephony server which runs browser software with user interaction provided via a telephone.

14. A method as claimed in claim 9, wherein the system includes a voice server for translating data commands to and from audio input using one of speech recognition and text to speech applications.

15. A method as claimed in claim 9, wherein the computer network is the Internet and the application server is a web server.

16. A computer program product stored on a computer readable storage medium, comprising computer readable program code means for performing the steps of:
receiving telephone calls via a telephone network;
accessing an application server via a computer network to obtain information in response to an audio input from a telephone call;
receiving a cookie from an application server relating to the access of the application server in response to an audio input from a telephone call;
linking the cookie to a telephone calling line identifier; and
storing the cookie for use during subsequent telephone calls from the same telephone calling line.
